(19) United States
(12) Patent Application Publication
(10) Pub. No.: US 2011/0073612 A1
(43) Pub. Date: Mar. 31, 2011

(54) Method and Apparatus for Door Handle Hygiene

(76) Inventor: Bradly Youssef, San Diego, CA (US)

(21) Appl. No.: 12/571,286

(22) Filed: Sep. 30, 2009

(51) Int. Cl. B65D 83/08; F16M 13/00

(52) U.S. Cl. 221/283; 248/342

(57) ABSTRACT

A restroom hygiene apparatus includes a plurality of generally rectangular hygiene sheets secured together along a first edge to form a hygiene pad and means for securing and suspending the hygiene pad from a door handle to enable at least one of the plurality of hygiene sheets to be removed to shield a user from direct contact with the door handle.

### FIELD OF THE INVENTIONS

The inventions described below relate to the field of hygiene and more specifically to the field of human hygiene associated with contact with restroom door handles and other entry and exit handles.

### BACKGROUND OF THE INVENTIONS

Public restroom cleanliness has long been a concern related to the transmission of disease. The rising prevalence of sexually transmitted diseases and other communicable diseases raise further concerns about maintaining personal hygiene in public restrooms and other sanitary facilities.

### SUMMARY

Restroom door hygiene may be maintained using one or more configurations of the disclosed apparatus secured to the inside of a restroom door, the inside handle or otherwise secured adjacent the inside door handle. A user of the restroom or other space may remove one or more sheets of paper or other suitable material from a roll or collection of sheets for use engaging the door handle. The used sheet or sheets may be disposed after use.

A roll or other collection of sheets may be any suitable paper, cloth and or plastic tissue, napkin or towel and may also be treated with a suitable antibacterial compound or other treatment consistent with the task of diminishing the transmission of disease and or microorganisms from restroom doors, push plates or handles. The sheets may have any suitable shape.

A restroom hygiene apparatus includes a plurality of generally rectangular hygiene sheets secured together along a first edge to form a hygiene pad and means for securing and suspending the hygiene pad from a door handle to enable at least one of the plurality of hygiene sheets to be removed to shield a user from direct contact with the door handle.

A hygiene system includes a plurality of hygiene sheets enclosed for distribution and use in a dispenser shaped like a truncated pyramid. The base of the truncated pyramid is removably secured to the inside surface of a restroom door or a wall adjacent the door placing the hygiene sheets in a convenient location for use. The shape of the dispenser minimizes projections for snagging clothing of people passing the dispenser.

A hygiene system includes a plurality of generally planar hygiene sheets stacked or folded together to form a hygiene pad, a hygiene sheet dispenser in the shape of a truncated pyramid having a top, a bottom and four inclined sides, the dispenser enclosing the hygiene pad, and a dispensing slot open in the top and extending through at least a portion of at least one of the four inclined sides to permit access to the hygiene sheets and withdrawal of a single sheet at a time through the dispensing slot.

### BRIEF DESCRIPTION OF THE DRAWINGS

FIG. 1 is a perspective view of a door and handle with a door hygiene pad.

FIG. 2 is a front view of an alternate door hygiene roll and support frame.

FIG. 3 is a perspective view of a door and handle with a hygiene apparatus secured on the door.

FIG. 4 is a cross-section view of the hygiene apparatus of FIG. 3 taken along A-A.

FIG. 5 is a cross-section view of an alternate hygiene apparatus.

FIG. 6 is a top view of the hygiene apparatus of FIG. 3.

### DETAILED DESCRIPTION OF THE INVENTIONS

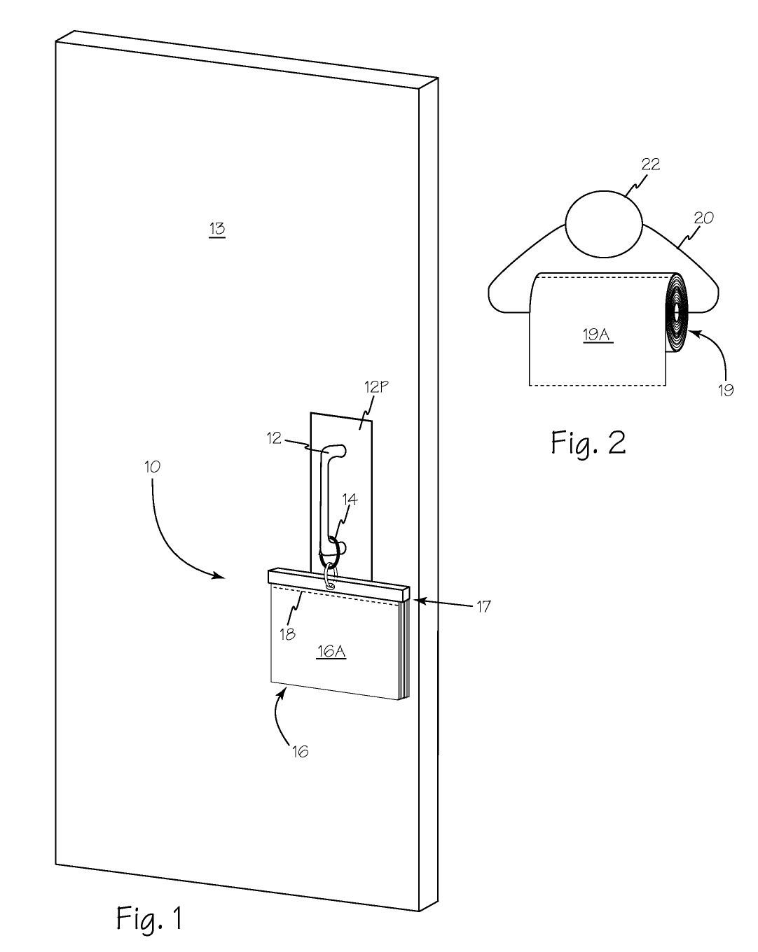

FIG. 1 is a perspective view of a door and handle with door hygiene pad 10 secured to handle 12 using attachment device 14. Attachment device may adopt any suitable configuration to secure the door hygiene pad to a door handle, knob or lever such as heavy cloth or strap material with a hook & loop fastener, a plastic or metal ring with a reclosable attachment, plastic or spring steel ring to frictionally engage the handle, knob or lever. Alternatively, attachment device 14 may be secured to door 13 adjacent to handle 12, or to the interior handle plate such as plate 12P door knob or lever rose.

Door hygiene pad 10 may be a collection of two or more removable sheets such as sheets 16 that may be collected, folded, woven, attached, secured or otherwise joined together to enable each sheet to be removed individually for use shielding a user's hand from direct contact with the door handle. For example, door hygiene pad 10 may include a plurality of sheets 16 secured together along edge 17. Perforations 18 may be formed through each sheet such as sheet 16A to enable each sheet to be individually removed for use and subsequent disposal.

Hygiene sheets 19A may also be formed into a roll such as hygiene sheet roll 19 illustrated in FIG. 2. Roll 19 may be supported by any suitable rack or frame such as frame 20. Frame 20 may enable easy replacement of an empty hygiene roll after all the hygiene sheets have been used. Connector 22 is used to secure frame 20 to a door handle, knob or lever.

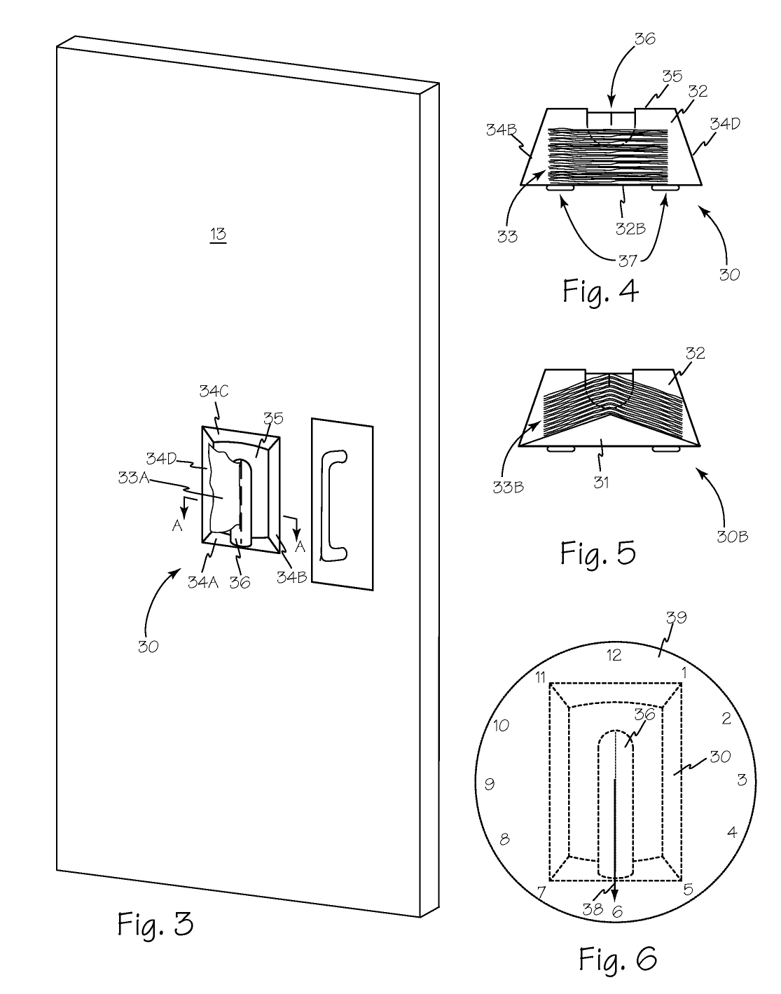

Referring now to FIGS. 3 and 4, hygiene apparatus 30 may be attached to any suitable structure such as a wall or door, such as door 13, near the entrance to a restroom or other sanitary facility. Hygiene apparatus 30 is composed of housing 32 and hygiene pad 33. Housing 32 is shaped generally like a truncated pyramid with base 32B connecting sides 34A, 34B, 34C and 34D and enclosed by top 35. Opening 36 extends through top 35 and at least one side such as side 34A. Opening 36 may be a rounded rectangle, oval or rectangle and may adopt any other suitable shape.

Base 32B releasably engages a suitable mounting surface such as door 13 using one or more mounting elements 37. Mounting elements may be adhesive strips or any other suitable attachment apparatus. Alternatively, mounting elements 37 may be one side of a hook and loop fastener and the corresponding hook or loop strip may be permanently secured to any suitable mounting location.

Hygiene pad 33 is composed of one or more hygiene sheets such as hygiene sheets 33A that are stacked or folded together to enable removal of a single sheet and the extension of a subsequent sheet through opening 36.

Referring now to FIG. 5, alternate hygiene apparatus 30B includes removable insert 31 for improving access to hygiene pad 33B. Alternatively, base 32B may be shaped to operate as an insert and retain hygiene pad 33B in close proximity to opening 36.

Referring now to FIG. 6, opening 36 includes a long axis 38 oriented toward the open side such as side 34A. Long axis 38 may be in any suitable clock orientation relative to clock face 39 with the 6 o'clock orientation preferred to enable gravity to retain hygiene pad 33 in contact with side 34A.

While the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. An apparatus comprising:
a plurality of generally rectangular hygiene sheets secured together along a first edge to form a hygiene pad;
means for securing and suspending the hygiene pad from a door handle to enable at least one of the plurality of hygiene sheets to be removed to shield a user from direct contact with the door handle.

2. The apparatus of claim 1 further comprising:
a generally linear series of perforations through each hygiene sheet near and generally parallel to the first edge.

3. An apparatus for restroom door hygiene comprising:
a plurality of generally planar hygiene sheets stacked together to form a hygiene pad;
a hygiene sheet dispenser in the shape of a truncated pyramid secured to the restroom door, the hygiene sheet dispenser having a top, a bottom and four inclined sides, the dispenser enclosing the hygiene pad;
a dispensing slot open in the top and at least a portion of at least one of the four inclined sides to permit access to the hygiene sheets and withdrawal of a single sheet at a time through the dispensing slot, the dispensing slot oriented in the six o'clock position.
